(19) United States
(12) Patent Application Publication
(10) Pub. No.: US 2011/0174614 A1
(43) Pub. Date: Jul. 21, 2011

(54) ELECTRODE, METHOD AND SYSTEM FOR DETERMINING AN ANALYTE IN A LIQUID MEDIUM

(76) Inventors: Itamar Willner, Mevasseret Zion (IL); Ran Tel-Vered, Jerusalem (IL); Ilina Baravik, Jerusalem (IL)

(21) Appl. No.: 12/999,359

(22) PCT Filed: Jun. 10, 2009
(86) PCT No.: PCT/IL09/00576

§ 371 Date: Apr. 7, 2011

(30) Foreign Application Priority Data
Jun. 16, 2008 (US) 61129271

(51) Int. Cl. G01N 27/30; C25B 11/04; C25B 9/00

(52) U.S. Cl. 204/403.14; 204/291; 204/292; 204/242

(57) ABSTRACT

Disclosed is an electrode for determining an analyte in a liquid medium, such as glucose in body subcutaneous fluids. The electrode includes a conductive surface and a matrix bound thereto. The matrix includes at least two species of components that comprise one or more species of enzymes and one or more species of metal nanonparticle. The components may be covalently bound to one another through one or more first binding moieties and the matrix may be covalently bound to the conductive surface through one or more same or different second binding moieties. The one or more enzyme species can catalyze a reaction in which an analyte is reacted to yield a product. The catalysis may alter the electric properties or response of the electrode.

### CROSS-REFERENCE TO RELATED APPLICATIONS

This application claims priority to provisional U.S. application Ser. No. 61/129,271, entitled “Electrode, Method and System for Determining an Analyte in a Liquid Medium” filed Jun. 16, 2008, the content of which is hereby incorporated by reference in its entirety.

### FIELD

This invention relates to electrodes, method and system for determining an analyte in a liquid medium, such as glucose in body subcutaneous fluids. The invention also concerns a process for preparing the electrodes.

### BACKGROUND

Numerous oxidases catalyze the oxidation of their specific substrates by molecular oxygen with the concomitant generation of H₂O₂ e.g., glucose oxidase.

The electrocatalytic reduction of H₂O₂ by horseradish peroxidase-funcitonalized electrodes or other hemoprotein-modified electrodes were used in biosensors for H₂O₂ and for the substrates of different oxidases.

Au nanoparticles (NPs) conjugated to redox enzymes were used to electrically contact the redox sites of the biocatalysts with electrodes, and to activate their bioelectrocatalytic functions. The catalytic enlargement of Au NPs associated with electrode enhanced the conductivity at enzyme-modified electrode surfaces, and this improved the bioelectrocatalytic functions of the modified electrodes. The catalytic growth of Au NPs by enzyme-generated H₂O₂ is known to enable the optical colorimetric detection of enzyme activities.

Some biomolecule-metal NP hybrids were used as catalytic labels for the amplified detection of specific bio-recognition events.

The art believed to be relevant as background to the present invention consists of the following:
Willner, B. Willner, Trends Biotechnol. 2001, 19, 222; b) A. Heller, Acc. Chem. Res. 1990, 23, 128
B. Willner, E. Katz, I. Willner, Curr. Opin. Biotechnol. 2006, 17, 589
I. Willner, E. Katz, Angew. Chem. Int. Ed. 2000, 39, 1180
P. N. Bartlett, P. Tebbutt, R. G. Whitaker, Prog. React. Kinetics 1991, 16, 55
D. L. Williams, A. P. Doig Jr., A. Korosi, Anal. Chem. 1970, 42, 118
P. Janda, J. Weber, J. Electroanal. Chem. 1991, 300, 119
Y. Degani, A. Heller, J. Am. Chem. Soc. 1988, 110, 2615
W. Schuhmann, Biosens. Bioelectron. 1995, 10, 181
I. Willner, A. Riklin, B. Shoham, D. Rivenson, E. Katz, Adv. Mater. 1993, 5, 912
B. A. Gregg, A. Heller, J. Phys. Chem. 1991, 95, 5970
A. Heller, J. Phys. Chem. 1992, 96, 3579
A. Heller, Phys. Chem. Chem. Phys. 2004, 6, 209
I. Willner, V. Heleg-Shabtai, R. Blonder, E. Katz, G. Tao, A. F. Bückmann, A. Heller, J. Am. Chem. Soc. 1996, 118, 10321
M. Zayats, E. Katz, I. Willner, J. Am. Chem. Soc. 2002, 124, 14724
Y. Xiao, F. Patolsky, E. Katz, J. F. Hainfeld, I. Willner, Science 2003, 299, 1877
M. Zayats, E. Katz, R. Baron, I. Willner, J. Am. Chem. Soc. 2005, 127, 12400
Y. Yan, R. Tel-Vered, O. Yehezkeli, Z. Cheglakov, I. Willner, Adv. Mater. DOI: 10.1002/adma.200703128.
M. Zayats, R. Baron, I. Popov, I. Willner, Nano Lett. 2005, 5, 21.
R. Polsky, R. Gill, L. Kaganovsky, I. Willner, Anal. Chem. 2006, 78, 2268.
I. Willner, R. Baron, B. Willner, Adv. Mater. 2006, 18, 1109

### SUMMARY

The present invention provides electrodes useful in determining an analyte in a liquid medium and sensing system and method comprising such electrodes.

The terms “determining” or “determination” will be used to denote both qualitative determination of presence of the analyte in a medium as well as a qualitative measurement intended to determine the level or concentration of the analyte in the medium. In accordance with the present invention the electric response or the electric properties of the electrodes (e.g. current-voltage relationship, impedance, etc.), which is altered in the presence of the analyte, is used as a basis for said determination. For a qualitative determination, a change in properties or response above a defined threshold may serve as an indication of the presence (or absence) of the analyte in the medium. For a quantitative determination, the level of the electric response or of the change in properties may determine the level of the analyte in the medium. At times, a calibration curve or may be used for a qualitative determination.

In accordance with one aspect of the invention there is provided an electrode comprising: a conductive surface and a matrix bound thereto; the matrix comprises at least two species of components that comprise one or more species of enzymes and one or more species of metal nanonparticle (NP), the components being covalently bound to one another through one or more first binding moieties and the matrix being covalently bound to the conductive surface through one or more same or different second binding moieties.

The one or more first and second binding moieties may be, according to some embodiments of the invention identical to one another or contain at least an identical functional group in it. According to other embodiments the one or more first moieties are different than the one or more second moieties.

According to a currently preferred embodiment, the first and second binding moieties are residues of electropolymerizable groups. The term “residues of electropolymerizable groups” means to denote that the covalent binding of the binding moieties is achieved, at least partially, through an electropolymerization process.

The conductive surface may be a metal body such as for example gold, platinum, silver, suitable alloys, etc. The conductive surface of the invention may also be a body made of other than pure metal such as, for example graphite, Indium-Tin-Oxide (ITO), etc.

As the electrical responsiveness of the electrode depends, among others, on the surface area of the conducting surface. According to some embodiments the surface area is increased by roughening or the use of a porous body. It should be noted that through such increase in specific surface area the overall size or dimensions of the electrode may be decreased.

The term “specie(s)” denotes a certain type of said component. For example, glucose oxidase is one enzyme specie, glucose dehydrogenase is another enzyme specie, cholesterol oxidase yet another specie, etc. Similarly platinum NPs are one specie of NPs, gold NPs are another, palladium NPs are a third type of NP specie, etc.

The terms “bind” or “bond”, “chemical bond” or any of their lingual derivatives refer to any form of establishing a substantially stable connection between different components and the biding moieties. A bond may include, for example, a single, double or triple covalent bond, complex bond, electrostatic bond, Van-Der-Waals bond, hydrogen bond, ionic bond or any combination thereof.

In accordance with a preferred embodiment of the invention, provided is an electrode that comprises: a conductive surface and a matrix bound thereto; the matrix comprises at least two species of components that comprise (i) one or more species of enzymes that catalyzes a reaction in which an analyte is reacted to yield a product and (ii) one or more species of metal NPs; the catalysis altering the electric properties of the electrode. Such an electrode may be used in determining an analyte in a medium. For such determination, the electrode, typically forming part of electrochemical cell including a counter electrode and optionally also a reference electrode is brought in contact with the medium in which the analyte is to be determined. An electrochemical cell including an electrode of the invention will be referred to herein as the “measuring unit”.

In some embodiments all components of the measuring unit—the electrode of the invention, the counter electrode and the optional reference electrode—are combined together to form one sensing device that may be, for example, implanted for in vivo determination of an analyte. Such a device will be referred to herein as “measuring device”.

In some embodiments of the invention the counter electrode is also an electrode of the invention. Configuration of the measuring unit according to such embodiments will be exemplified below. In accordance with other embodiments the counter electrode is not an electrode of the invention and may, for example, be made of graphite, of metal, oxidized metal, and electrode made of metal with a surface comprising metal salts, and others.

For determination of the analyte, the electrical responsiveness of the electrode is determined through the passage of a current or application of a voltage onto the electrode. In accordance with some embodiments, direct current is used in such determination. In accordance with other, preferred embodiments, a time-varied current or voltage is used. A typical mode of measuring the electrical response is through the use of cyclic voltammograms.

The enzyme is typically a redox enzyme, such as for example, glucose oxidase, lactate oxidase, choline oxidase, cholesterol oxidase or any combination thereof. Through the catalytic activity of a redox enzyme a substrate of the enzyme is converted into a product and in this process electrons are either consumed (in case of reduction) or released (in case of oxidation). In case of an oxidation by an oxidase enzyme, the electron for the oxidation reaction is released through a parallel reduction reaction in which oxygen and water are reacted to yield hydrogen peroxide (H₂O₂). The reductions of H₂O₂ can then be catalyzed by a metal NP such as platinum (Pt) and the electrons needed therefor can flow from the conductive surface. Thus, upon energizing the conductive surface, the electric response of the electrode can then be used, in accordance with the invention, as a measure of the oxidation reaction. The level of the oxidation reaction is indicative of the presence and/or level of the analyte, which is the substrate of the enzyme, which may thereby be determined. For example, where the enzyme is glucose oxidase in the presence of glucose in the medium, the glucose will be oxidized into gluconic acid while yielding H₂O₂ in the manner described above. The electric response of the electrode upon energizing it, will determine the existence and at times also level of glucose in the medium.

In another embodiment, catalytically relatively inert NPs such as Au NPs are used. In such a case, in the absence of the NPs which can catalyze the oxidation of H₂O₂ there will be direct electron transfer from the conductive surface to the enzyme. Typically, the linker groups that link between the different components of the matrix and between the matrix and the conductive surface are of kind that allows them to participate in the electron mediation between the different components.

Also in the case of a reduction reaction by a reductase, there will be a net flux of electrons through the metal NP to the conductive surface. Thus, energizng the electrode will give rise to an altered electric response of the electrode that will serve for determination of the analyte in the medium. For example, the reductase enzyme may be glucose reductase for use in determining glucose in the medium.

In accordance with some embodiments of the invention, the metal NP play an active catalytic role in altering the electric response of the electrode in the presence of the analyte, such as in the case of Pt NPs, which catalyze H₂O₂ into H₂O while consuming electrons. In accordance with other embodiments, the metal NPs do not play a substantial catalytic role and serve primarily for transfer of electrons to or from the conductive surface. This is the case, for example, with gold (Au) NPs.

In accordance with some embodiments of the invention at a combined use of NPs that play an important catalytic role and such that do not may be used, e.g. a combination of Au and Pt NPs. A matrix comprising a combination of such NPs may typically also comprise a combination of an oxidase and a reductase enzymes. The oxidase enzyme will typically operate when the conductive surface is negatively charged while reductatse enzyme when the conductive surface is positively charged.

In other embodiments two electrode may be used, one being a cathode and one an anode, carrying matrices with respective oxidase and reductase enzymes, respectively. The matrix with the oxidase enzyme will also comprise an NP that can catalyze the reduction reaction of H₂O₂, e.g. Pt, Ni, Pd, Rh, etc.; that with the reductase enzyme will include the relatively inert NPs, e.g. Au, Ag, etc.

The metal nanoparticles may be one or more of Pt, palladium (Pd), iridium (Ir), Au, Ag, Ni, TI, etc. The size of the metal nanoparticles may range from about 1 nm to 200 nm.

The different components of the matrix and the conductive surface are linked to one another by linker groups which in some embodiments may also play a role in electron mediation across the matrix and to or from the conductive surface. An example of such a linker is thioaniline, thioaniline dimer or oligomers thereof.

In one embodiment of the invention, the components of an electrode of the invention, are bound to one another. Such bonding may be for example a covalent covalent, complex bond, electrostatical bond, Van-Der-Waals bond, hydrogen bond, ionic bond or any combination thereof. The bonding may be direct between the components, such as for example NP-NP, NP-Enzyme, NP-conductive surface, Enzyme-Enzyme, Enzyme-conductive surface. In another embodiment the bonding between the components of the electrode of the invention are made through a linker group, as will be detailed further below.

In one embodiment of the invention said matrix is linked to the conductive surface by a linker group having the general formula (I):

Z-L-X (I)

wherein Z is a moiety that can chemically associate with, bind to or chemically sorb onto the conductive surface; L is a chemical bond or a spacer group; and X is a functional group that can bind to one or more other X groups or other functional groups linked to the enzyme or a nanoparticles to form said second binding moiety. In one embodiment Z is a sulfur-containing moiety and X is an aniline group which may be conjugated to L or directly to Z (where L is a chemical bond) through the meta- ortho- or para-position. In a further embodiment said linkers are thioaniline groups or oligomers thereof.

In a further embodiment of the invention, said nanoparticles are linked to one or more of (i) the conductive surface and (ii) at least one other component of the matrix through linker groups of the general formula (II):

Z′-L′-X′ (II)

wherein Z′ may be the same or different than Z and is a moiety that can chemically associate with, bind to or chemically sorb onto the nanoparticle; L′ is a chemical bond or a spacer group; and X′ is a functional group that can bind to one or more other X′ groups or other functional groups linked to the conductive surface to form said second binding moiety or an enzyme to form said first binding moiety. In one embodiment Z′ is a sulfur-containing moiety and X′ is an aniline group which may be conjugated to L′ or directly to Z′ (where L′ is a chemical bond) through the meta- ortho- or para-position. In a further embodiment said linkers are thioaniline groups or oligomers thereof.

In a further embodiment the metal nanoparticle may be protected prior to their incorporation into the matrix, e.g. by the method described below, by at least one protecting group. In one embodiment said protecting group is of the general formula (III):

Z′″-L′″-W (III)

wherein Z′″ may be the same or different than Z and is a moiety that can chemically associate with, bind to or chemically sorb onto the nanoparticle; L′″ is a chemical bond or a spacer group; and W is a charged functional group, e.g. SO₃⁻, COO⁻, NO₃⁻², PO₃⁻². The charged functional group may be either negative or positive. In one embodiment said protecting group is mercaptoethanesulforic acid.

In another embodiment of the invention said enzymes are linked to one or more of (i) the conductive surface and (ii) at least one other component of the matrix through linker groups of the general formula (IV):

—Y-L″-X″ (IV)

wherein —Y is a moiety that is covalently bound to the enzyme; L″ is a chemical bond or a spacer moiety; and X″ is a functional group that can bind to one or more other X″ group or other functional groups linked to the conductive surface to form said second binding moiety or a nanoparticle to form said first binding moiety. In one further embodiment —Y is a moiety bound to the enzyme by an amide bond; and X″ is an aniline group which may be conjugated to L″ or directly to Y (where L is a chemical bond) through the meta- ortho- or para-position. In another embodiment X″ is thioaniline group or oligomers thereof.

The term “spacer moiety” as used herein may be C₁-C₅ straight or branched alkylene, C₁-C₅ straight or branched alkenylene, C₁-C₅ straight or branched alkynylene, C₅-C₁₀ arylene, C₅-C₁₀ heteroarylene, all of which may be optionally substituted.

The term “functional group” as used herein relates to a specific group of atoms within a molecule that is responsible for a characteristic chemical reaction of that molecule. In the context of the present invention a functional group may be selected from the following non-limiting list: aniline, pyrrole, thiophene, indole, thianaphene, carbazole, azulene, fluorene, triphenylene, benzenoid and nonbenzenoid polycyclic hydrocarbon, each optionally substituted, or any other polymerizable or electropolymerizable functional group known to a person skilled in the art.

In some embodiments of the invention said first binding moiety has one of the following general formulae (V)-(VII):

Z′-L′-X′—X′-L′-Z′ (V)

Z′-L′-X′—X″-L″-Y— (VI)

—Y-L″-X″—X″-L″-Y— (VII)

wherein Z′, L′, L″, X′, X″, and Y having the meanings as defined above.

In some embodiments said second binding moiety has one of the following general formulae (VIII) and (IX):

Z-L-X—X′-L′-Z′ (VIII)

Z-L-X—X″-L″-Y— (IX)

wherein Z, Z′, L, L′, L″, X, X′, X″ and Y having the meanings as defined above.

In some embodiments of the invention said matrix is formed through an electroploymerization process. In such a process the conductive surface is functionalized with a precursor layer of groups, e.g. the group of formula (I) is contacted in an electrolytic, e.g. aqueous medium with the other components of the matrix and thorough energizing the conductive surface under DC, e.g. constant current or constant voltage conditions, AC or other forms of cyclic voltage, the X, X′ and X″ groups bind to one another to thereby yield said matrix.

In accordance with one embodiment there is provided a process of preparing an electrode of the invention for the detection of an analyte in a medium comprising: forming a layer on a surface of a conductive surface comprising at least one group having the general formula (I):

Z-L-X (I)

wherein Z, L and X having the meanings as defined above;

contacting the layered conductive surface with at least two types of components comprising: (i) at least one metal nanoparticle species bonded to at least one group of the general formula (II):

Z′-L′-X′ (II)

wherein Z′, L′ and X′ having the meanings as defined above; and (ii) at least one enzyme species covalently bonded to at least one group of the general formula (IV):

—Y-L″-X″ (IV)

wherein —Y, L″ and X″ having the meanings as defined above; and electropolymerizing said components and said layer to cause binding of functional groups X, X′ and X″ to one another to form a matrix comprising one or more enzyme species and one or more metal nanonparticle species, the matrix being bound to said conductive surface .

Binding of any one of groups X, X′ and X″ to one or more other X, X′ and X″ groups or other functional groups linked to the conductive surface, a nanoparticle or an enzyme as defined hereinabove, may occur due to any kind of chemical or electrochemical reaction, such as for example nucleophilic/electrophilic substitution reaction, aromatic substitution reaction, addition reactions, redox reactions, polymerization reactions, coupling reactions, electropolymerization reaction etc.

Also provided by the invention is a sensor system for determining an analyte in a medium that comprises an electrode as defined and described herein. The sensor system typically comprises a module for energizing the electrode and a module for determining (and optionally recording and/or displaying) the electric response of the electrode to said energizing.

The invention also provided a measuring unit and a measuring device comprising at least one electrode of the invention. By some embodiments of the invention the electrode or the measuring device are implantable and used for in vivo continuous monitoring of the presence, level, level changes, etc., of an analyte within the body of a subject.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A is a schematic illustration of the manner of synthesis of a monolayer of platinum nanoparticles (Pt NPs) through covalent binding of thioaniline-modified Pt NPs and mercaptopropionic acid-modified Au electrodes (A) and of a 3D oligoaniline-crosslinked Pt NPs array by the electropolymerization of the thioaniline-modified Pt nanoparticles on the thioaniline-modified Au electrodes (B).

FIG. 1B is a schematic illustration of the manner of modification of glucose oxidase with a polymerizable aniline functionality (A) and the subsequent synthesis of a 3D oligoaniline-crosslinked GOx/Pt NPs array by the electropolymerization of the thioaniline-modified GOx and thioaniline-modified Pt nanoparticles, on the thioaniline-modified Au electrodes (B).

FIG. 1C is a schematic illustration of the manner of modification of glucose oxidase with a polymerizable aniline functionality (A) and the subsequent synthesis of a 3D oligoaniline-crosslinked Au NPs/GOx array by the electropolymerization of the thioaniline-modified GOx and thioaniline-modified Au nanoparticles, on the thioaniline-modified Au electrodes (B).

FIG. 2A is a schematic representation of the electron transition on an oligoaniline-crosslinked GOx/Pt NPs array-modified Au electrode upon presence of glucose in the medium.

FIG. 2B is a schematic representation of the electron transition on an oligoaniline-crosslinked GOx/Au NPs array-modified Au electrode upon presence of glucose in the medium.

FIG. 3 shows cyclic voltammograms obtained with the Pt NPs monolayer-modified Au electrodes in a 0.1 M phosphate buffer solution (pH=7.4), containing different concentrations of hydrogen peroxide: (a) 0.0 mM; (b) 0.4 mM; (c) 0.8 mM; (d) 1.2 mM; (e) 2.0 mM; (f) 3.0 mM; (g) 4.0 mM; (h) 5.0 mM; (i) 6.0 mM; (j) 7.0 mM. Scan rate was 10 mV·s⁻¹. The inset shows a calibration curve corresponding to the electrocatalytic currents measured at E=31 0.35 V for different concentrations of hydrogen peroxide.

FIG. 4A shows cyclic voltammograms obtained with the oligoaniline-crosslinked GOx/Pt NPs array-modified Au electrodes in a 0.1 M phosphate buffer solution (pH=7.4), containing different concentrations of hydrogen peroxide: (a) 0.0 mM; (b) 0.05 mM; (c) 0.1 mM; (d) 0.2 mM; (e) 0.4 mM; (f) 0.8 mM; (g) 1.2 mM; (h) 2.0 mM; (i) 3.0 mM; (j) 4.0 mM; (k) 5.0 mM; (l) 6.0 mM. Scan rate was 10 mV·s⁻¹. The electrodes were prepared by the application of 60 cyclic voltammetry scans between −0.1 and 1.1 V vs. a saturate calomel electrodes (SCE) at 100 mV·s⁻¹. The inset shows a calibration curve corresponding to the electrocatalytic currents measured at E=−0.35 V for the variable concentrations of hydrogen peroxide.

FIG. 4B shows a comparison of the catalytic currents obtained for variable concentrations of hydrogen peroxide using: (a) An oligoaniline-crosslinked GOx/Pt NPs array-modified Au electrode, and, (b) A Pt NPs monolayer-modified Au electrode.

FIG. 5 shows cyclic voltammograms obtained with an oligoaniline-crosslinked Pt NPs array-modified Au electrodes in a 0.1 M phosphate buffer solution (pH=7.4) containing 0.5 mg·ml⁻¹ GOx and different concentrations of glucose: (a) 0 mM; (b) 3 mM; (c) 4.5 mM; (d) 7 mM; (e) 10 mM; (f) 14 mM; (g) 23 mM; (h) 34 mM; (i) 56 mM; (j) 82 mM; (k) 110 mM. Following the addition of glucose, the electrodes were immersed for 4 minutes in the electrolyte solution. Scan rate 10 mV s⁻¹. The electrodes were prepared by the application of 60 cyclic voltammetry scans between −0.1 and 1.1 V vs. SCE at 100 mV·s⁻¹. The inset shows a calibration curve corresponding to the electrocatalytic currents measured at E=−0.35 V for the variable concentrations of glucose.

FIG. 6A shows cyclic voltammograms obtained with an oligoaniline-crosslinked GOx/Pt NPs array-modified Au electrodes in a 0.1 M phosphate buffer solution (pH=7.4) containing different concentrations of glucose: (a) 0 mM; (b) 3 mM; (c) 7 mM; (d) 10 mM; (e) 14 mM; (f) 28 mM; (g) 42 mM; (h) 56 mM; (i) 64 mM; (j) 82 mM; (k) 96 mM; (l) 110 mM; (m) 134 mM; (n) 152 mM; (o) 166 mM. Following the addition of glucose, the electrodes were immersed for 4 minutes in the electrolyte solution. The shows inset shows a calibration curve corresponding to the electrocatalytic currents measured at E=−0.35 V for the variable concentrations of glucose.

FIG. 6B shows cyclic voltammograms obtained with an oligoaniline-crosslinked GOx/Pt NPs array-modified Au electrodes in a 0.1 M phosphate buffer solution (pH=7.4) containing: (a) 0 mM glucose; (b) 64 mM glucose; (c) following the addition of catalase, 2000 units, to (b). Prior to the measurements, the electrode was immersed for 4 minutes in the respective electrolytes.

FIG. 6C shows cyclic voltammograms obtained with an oligoaniline-crosslinked GOx/Pt NPs array-modified Au electrodes in a 0.1 M phosphate buffer solution (pH=7.4) containing 1 mM of ferrocenemethanol and different concentrations of glucose: (a) 0 mM; (b) 2.5 mM; (c) 5 mM; (d) 10 mM; (e) 15 mM; (f) 20 mM; (g) 30 mM; (h) 40 mM; (i) 50 mM; (j) 60 mM. For all measurements the scan rate was 10 mV·s⁻¹. The electrodes were prepared by the application of 60 cyclic voltammetry scans between −0.1 and 1.1 V vs. SCE at 100 mV·s⁻¹.

FIG. 7 shows electrocatalytic currents corresponding to oligoaniline-crosslinked GOx/Pt NPs arrays-modified Au electrodes, prepared by the application of 60 cyclic voltammetry scans between −0.1 and 1.1 V vs. SCE at 100 mV·s⁻¹, in the presence of 0.4 mg·mL⁻¹ Pt NPs and variable concentrations of GOx. Measurements were performed in a 0.1 M phosphate buffer solution (pH=7.4) containing 14 mM glucose. Following the addition of glucose, the electrodes were immersed for 4 minutes in the electrolyte solution. The indicated currents were measured at E=−0.35 V by cyclic voltammetry, at a scan rate of 10 mV·s⁻¹.

FIG. 8A shows electrocatalytic currents obtained with an oligoaniline-crosslinked GOx/Pt NPs arrays-modified Au electrodes, prepared by the application of different number of cyclic voltammetry scans between −0.1 and 1.1 V vs. SCE at 100 mV·s⁻¹, in the presence of 0.4 mg·mL⁻¹ Pt NPs and 0.5 mg·mL⁻¹ GOx. Measurements were performed in a 0.1 M phosphate buffer solution (pH=7.4) containing 56 mM glucose. Following the addition of glucose, the electrodes were immersed for 4 minutes in the electrolyte solution. The indicated currents were measured at E=−0.35 V by cyclic voltammetry, performed at 10 mV·s⁻¹.

FIG. 8B shows cyclic voltammograms obtained with an oligoaniline-crosslinked GOx/Pt NPs array-modified Au electrodes in a 0.1 M phosphate buffer solution (pH=7.4) containing 14 mM glucose. Following the addition of glucose, the electrodes were immersed in the electrolyte solution for: (a) 0 min; (b) 0.5 min; (c) 1 min; (d) 2 min; (e) 3 min; (f) 4 min; (g) 6 min. Scan rate 10 mV·s⁻¹. The electrodes were prepared by the application of 60 cyclic voltammetry scans between −0.1 and 1.1 V vs. SCE at 100 mV·s⁻¹, in the presence of 0.4 mg·mL⁻¹ Pt NPs and 0.5 mg·mL⁻¹ GOx. The inset shows the dependence of the electrocatalytic currents, measured at E=−0.35 V, on the time intervals of interaction between the glucose and the GOx/Pt NPs array.

FIG. 9 shows cyclic voltammograms obtained with an oligoaniline-crosslinked GOx/Au NPs array-modified Au electrodes in a 0.1 M phosphate buffer solution (pH=7.4) containing different concentrations of glucose: (a) 0 mM; (b) 20 mM; (c) 40 mM; (d) 60 mM; (e) 80 mM; (f) 100 mM; (g) 120 mM; (h) 140 mM. Scan rate 5 mV·s⁻¹ . Inset: calibration curve corresponding to the electrocatalytic currents measured at E=0.3 V for the variable concentrations of glucose. Prior to every scan, N₂ was bubbled through the cell for 10 minutes. The electrodes were prepared by the application of 60 cyclic voltammetry scans between −0.1 and 1.1 V vs. SCE at 100 mV·s⁻¹, using a thioaniline-modified Au NPs:thioaniline-modified GOx molar ratio of 3.6.

FIG. 10 shows electrocatalytic currents obtained with an oligoaniline-crosslinked GOx/Au NPs arrays-modified Au electrodes, prepared by the application of 60 cyclic voltammetry scans between −0.1 and 1.1 V vs. SCE at 100 mV·s⁻¹, in the presence of 0.5 mg mL⁻¹ thioaniline-modified GOx and variable concentrations of thioaniline-modified Au NPs. Measurements were performed in a 0.1 M phosphate buffer solution (pH=7.4) containing 60 mM glucose. The indicated currents were measured at E=0.3 V by cyclic voltammetry, performed at 5 mV·s⁻¹. Prior to the scans, N₂ was bubbled through the cell for 10 minutes.

FIG. 11 shows electrocatalytic currents obtained with an oligoaniline-crosslinked GOx/Au NPs arrays-modified Au electrodes, prepared by the application of variable number of cyclic voltammetry scans between −0.1 and 1.1 V vs. SCE at 100 mV·s⁻¹, in the presence of thioaniline-modified GOx:thioaniline-modified Au NPs molar ratio of 1.2. Measurements were performed in a 0.1 M phosphate buffer solution (pH=7.4) containing 60 mM glucose. The indicated currents were measured at E=0.3 V by cyclic voltammetry, performed at 5 mV·s⁻¹. Prior to the scans, N₂ was bubbled through the cell for 10 minutes.

FIG. 12 shows cyclic voltammograms obtained with oligoaniline-crosslinked GOx/Au NPs array-modified Au electrodes in a 0.1 M phosphate buffer solution (pH=7.4) containing different concentrations of glucose: a) 0 mM; (b) 20 mM; (c) 40 mM; (d) 60 mM; (e) 80 mM; (f) 100 mM; (g) 120 mM; (h) 140 mM; (i) 160 mM. Scan rate 5 mV·s⁻¹. The inset shows a calibration curve corresponding to the electrocatalytic currents measured at E=0.3 V for the variable concentrations of glucose. Prior to every scan, N₂ was bubbled through the cell for 10 minutes. The electrodes were prepared by the application of 60 cyclic voltammetry scans between −0.1 and 1.1 V vs. SCE at 100 mV·s⁻¹, using a thioaniline-modified Au NPs:thioaniline-modified GOx molar ratio of 1.2.

FIG. 13 shows cyclic voltammograms obtained with an oligoaniline-crosslinked GOx/Au NPs array-modified Au electrodes in a 0.1 M phosphate buffer solution (pH=7.4) containing: (a) pure buffer; (b) 0.1 mM ascorbic acid; (c) 60 mM glucose; (d) 60 mM glucose and 0.1 mM ascorbic acid. Scan rate 5 mV·s⁻¹. Prior to every scan, N₂ was bubbled through the cell for 10 minutes. The electrodes were prepared by the application of 60 cyclic voltammetry scans between −0.1 and 1.1 V vs. SCE at 100 mV·s⁻¹, using a thioaniline-modified Au NPs:thioaniline-modified GOx molar ratio of 1.2.

FIG. 14 shows cyclic voltammograms obtained with a high surface area oligoaniline-crosslinked GOx/Au NPs array-modified Au electrodes, following the pretreatment of the Au surfaces with Hg for 2 minutes and the removal of the amalgamated layer by concentrated HNO₃. The measurements were performed in a 0.1 M phosphate buffer solution (pH=7.4) containing different concentrations of glucose: (a) 0 mM; (b) 20 mM; (c) 40 mM; (d) 60 mM; (e) 80 mM; (f) 100 mM; (g) 120 mM; Scan rate 5 mV·s⁻¹. The inset shows a calibration curve corresponding to the electrocatalytic currents measured at E=0.3 V for the variable concentrations of glucose. Prior to every scan, N₂ was bubbled through the cell for 10 minutes. The electrodes were prepared by the application of 60 cyclic voltammetry scans between −0.1 and 1.1 V vs. SCE at 100 mV·s⁻¹, using a thioaniline-modified Au NPs:thioaniline-modified GOx molar ratio of 1.2.

### DETAILED DESCRIPTION

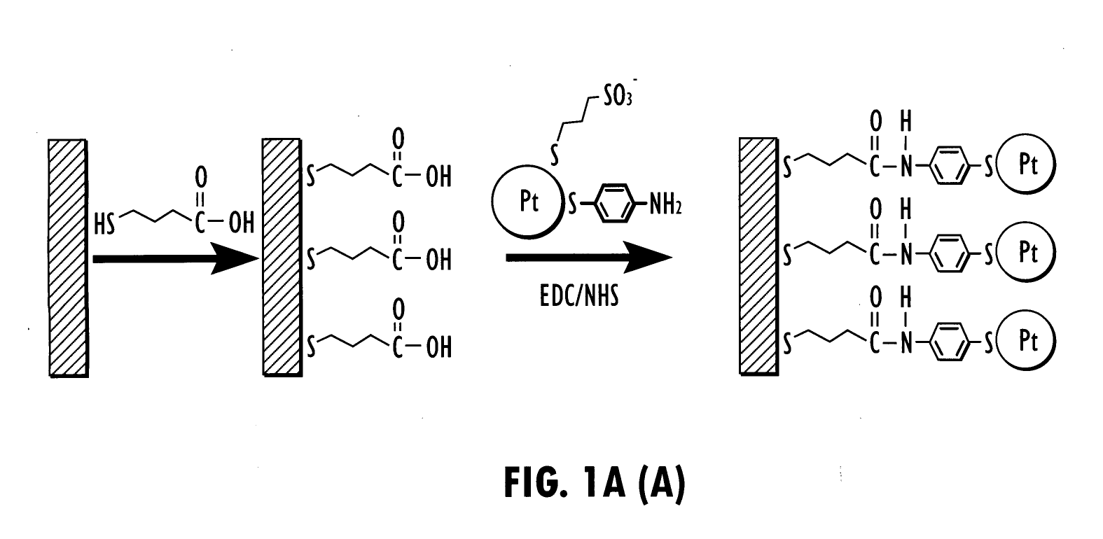

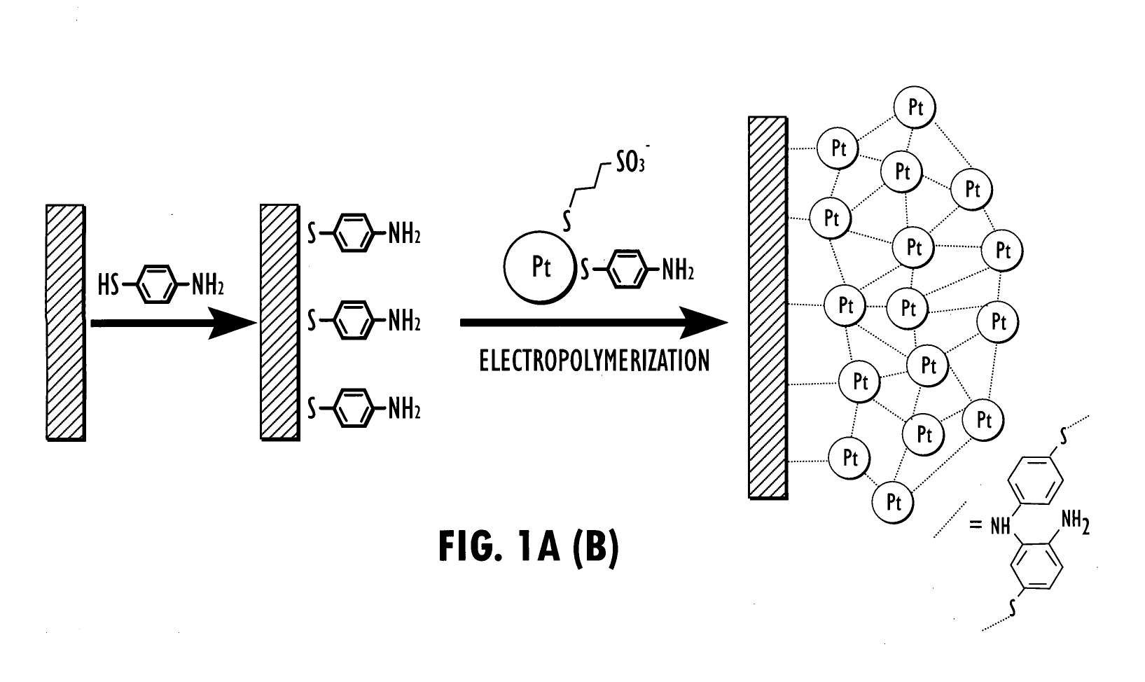

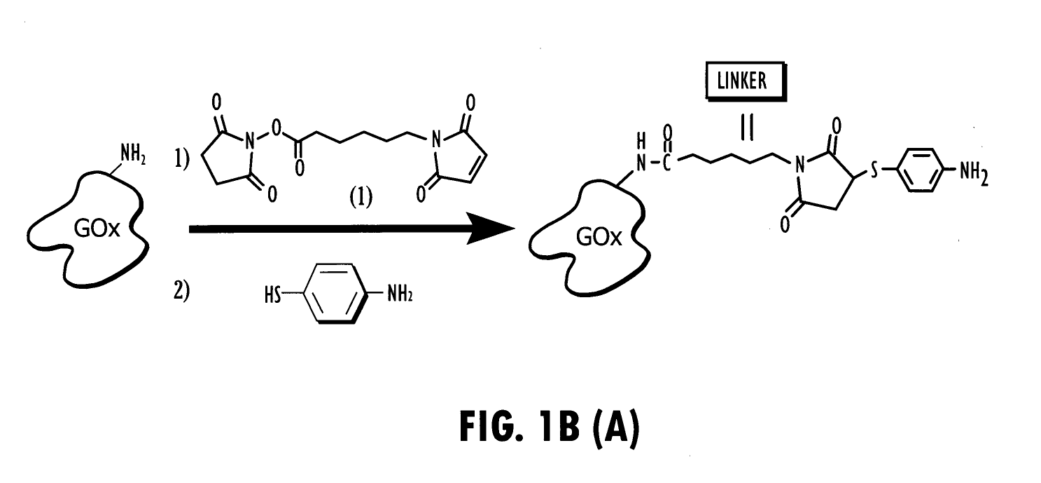

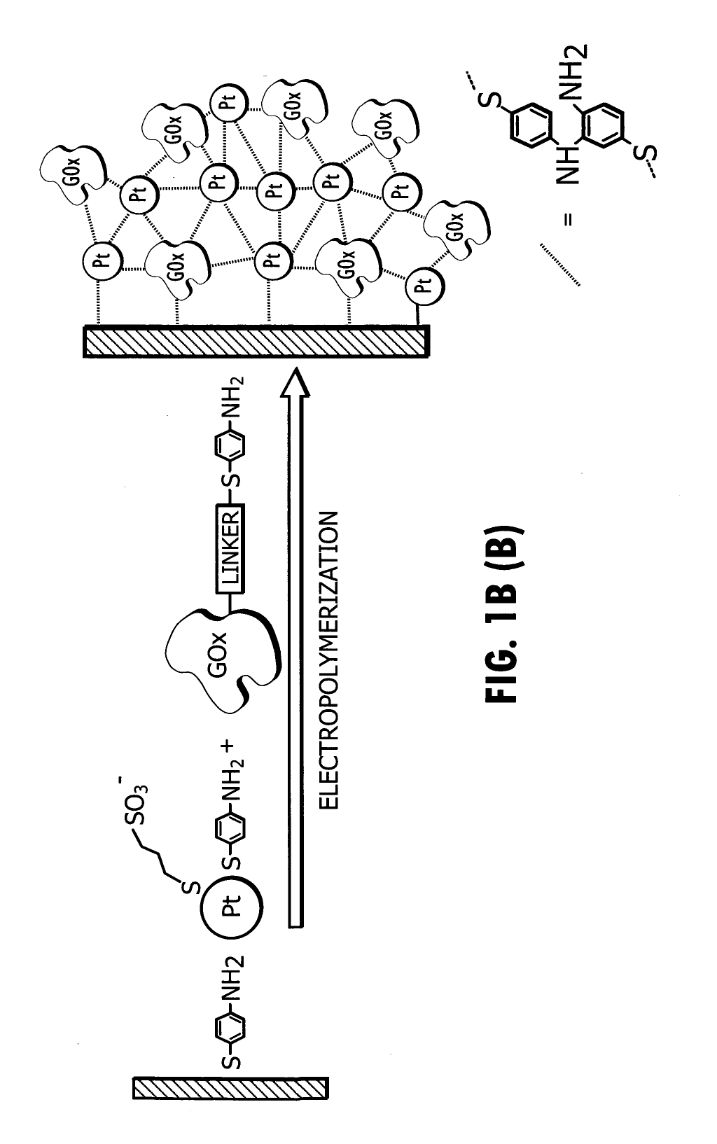

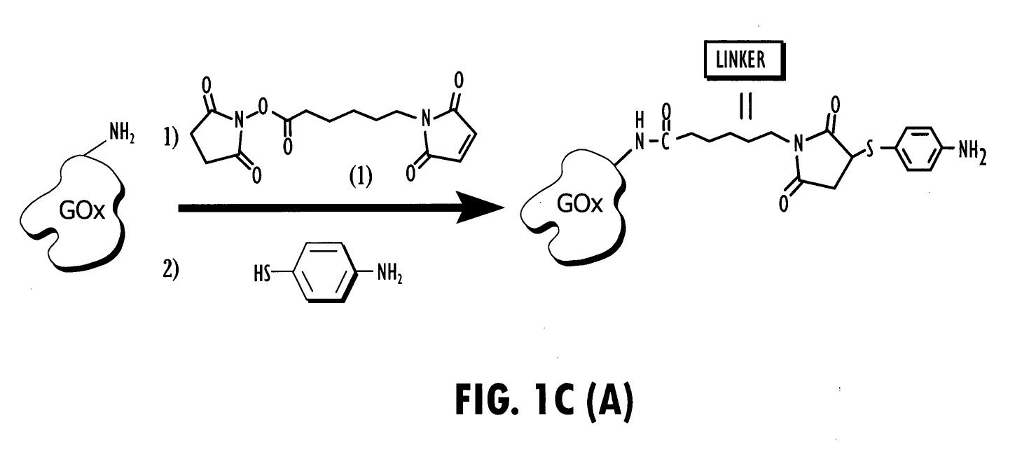

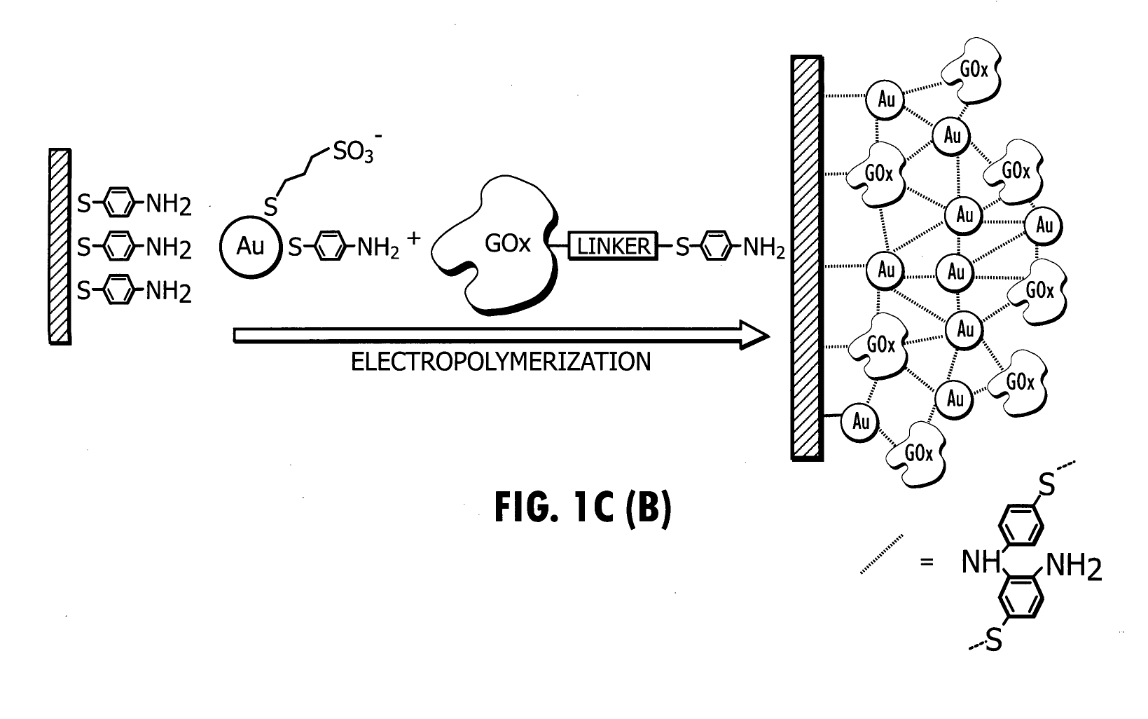

A manner of preparing an electrode in accordance with an embodiment of the invention is illustrated in FIG. 1B. In this specific example the enzyme is glucose oxidase (GOx) and the resulting electrode may thus be used for determining glucose in a medium. As will be appreciated this is only an illustrative example of the wider scope of the invention as defined herein.

In an initial preparatory step (A) the GOx is first modified by reacting it with N-(maleimidocaproyloxy) sulfosuccinimide ester (1), whereby the ester bond is broken and the maleimidic residue becomes bonded to the enzyme through and amidic bond. A thioaniline (2) is then reacted so as to bind to the maleimide ring as shown. Thus, a group with a linker moiety and an electropolymerizable aniline moiety is formed thereby. Each enzyme may be linked to more than 1such group. As will be appreciated, the use of N-(maleimidocaproyloxy) sulfosuccinimide ester and the thioaniline to give rise to said group is but an example and other molecules that can give rise to a polymerizable or electropolymerizable linker moiety to link to the enzyme and also other electropolymerizable moieties may be used. Furthermore, while preparation of the electrode of the invention through electropolymerization is a currently preferred embodiment, other manners of binding between functional groups may also be used to form the matrix on the metal body. Thus, functional groups other than such that are electropolymerizable may be included in accordance with the invention.

As shown under (B) in FIG. 1B, a conductive surface (represented schematically as a gray bar) is reacted with thioanile giving rise to a monolayer of immobilized thioanline molecules. The aniline moiety is electropolymerizable, as noted above. As will be clear to a person versed in the art, rather than aniline, other electropolymerizable moieties may be used instead of aniline and the invention is not limited thereto. Also, any moiety other than sulphur that can bind or sorb to the metal substrate may be used in accordance with the invention. A specific example of a conductive surface is Au but metal bodies other than Au made, for example, of Pt, Ag, Cu, Ni, and others, may be used. The manner of binding to form a monolayer with a functional group, e.g. electropolymerizable group, may be adapted according to the nature of the conductive surface. Also, similarly as above, while a functional group that is electropolymerizable is preferred, other functional groups are not excluded.

Pt NPs are reacted with thioaniline and with a mercatoethene sulphonic acid, to give rise to modified Pt NPs, which thereby become water soluble. The aniline is a group, as noted above, that lends itself to electropolymerization. The mercatoethene sulphonic acid serves as a protecting group to inhibit the aggregation and sedimentation of the modified Pt NPs. Similarly as above, the thioanline is a non-limiting example and groups with other functional moieties or with a moiety other than sulphur that can bind or sorb to the Pt NPs may be used as well. Similarly the mercatoethan sulphonic acid is also but a non-limiting example of protecting group.

Through an electropolymerization reaction a conductive surface with a matrix as illustrated on the right side of the figure, immobilized thereon, is formed. The electropolymerization typically proceeds through a number of cycles to increase the thickness of the matrix. It was found in accordance with the invention that there is an optimum to the number of cycles as far as achieving a maximum electrical response in the presence of an analyte, glucose in this specific example. Linking the different components of the matrix (GOx and Pt NPs) in this specific embodiment are linkers with a thioaniline dimer (bisthioaniline) or oligothioaniline.

FIG. 1C illustrates the manufacture of an electrode in which Pt is replaced by Au.

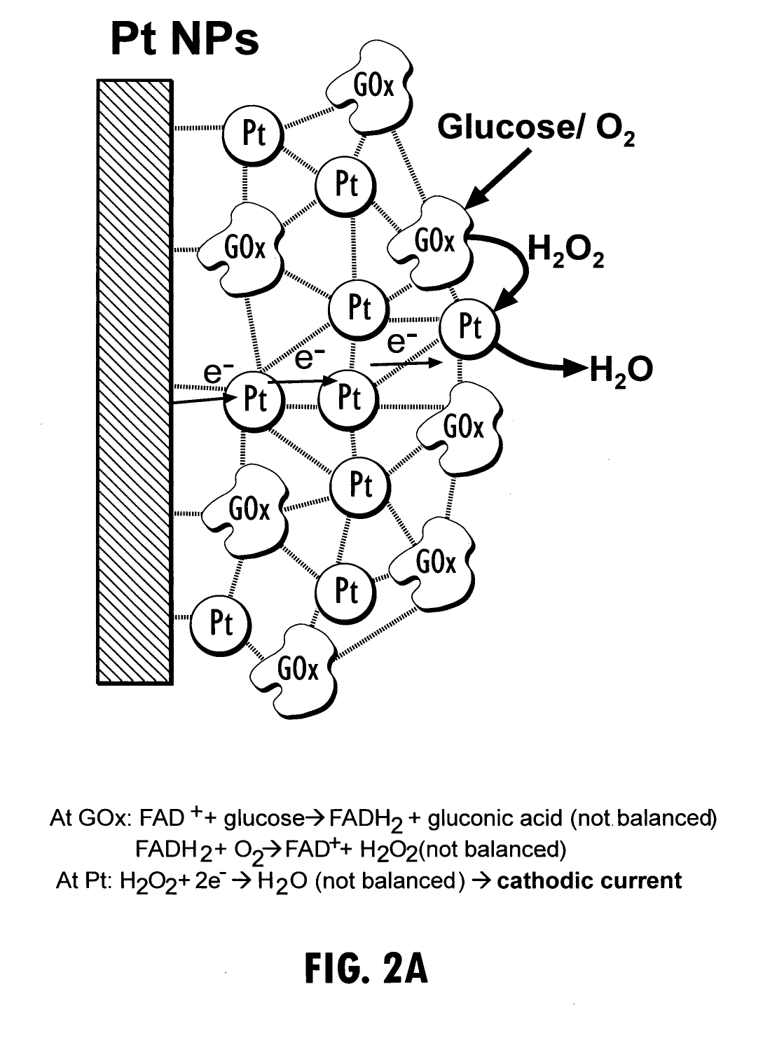

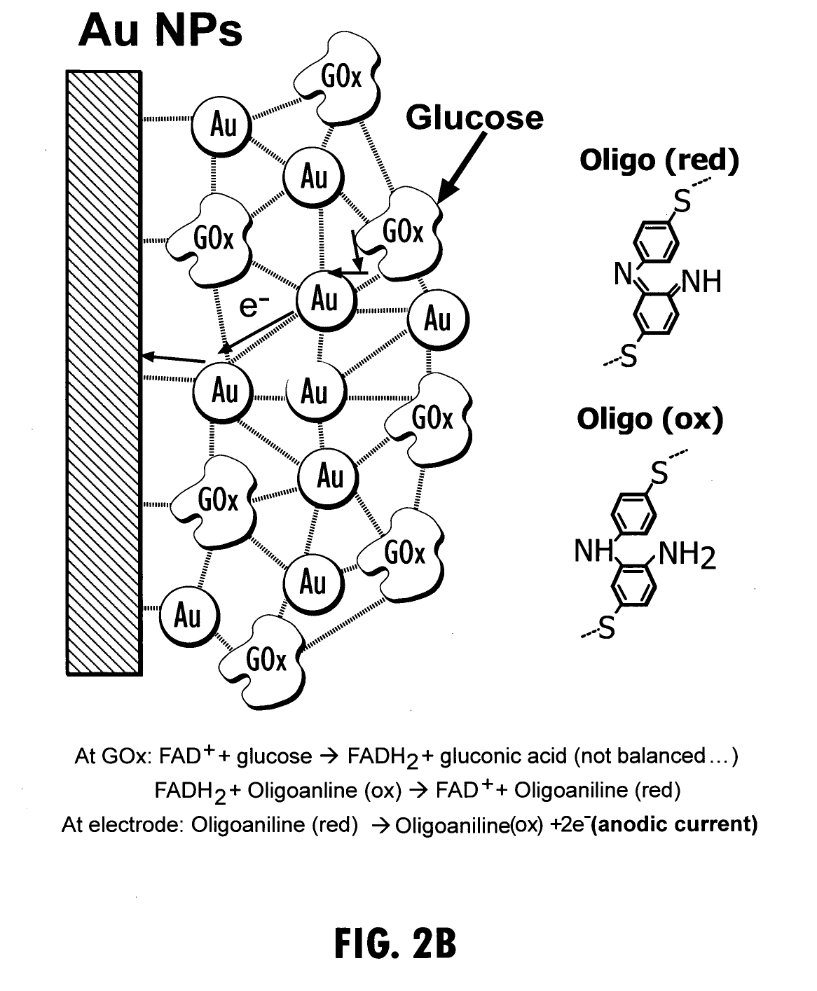

Reference is made to FIG. 2A which shows a schematic representation of the theoretical cathodic current achieved with an oligothioaniline-crosslinked GOx/Pt NPs array-modified Au electrode, of the kind obtained as shown in FIG. 1B, in the presence of glucose in the medium. However, the theory behind FIG. 2A is non-binding and the invention is not limited thereby. As can be appreciated from the illustration GOx immobilized enzyme, using the FAD co-factor, oxidizes glucose with O₂ to form gluconic acid and H₂O₂. The adjacent Pt NP in the matrix formed on the electrode catalyze the reduction of hydrogen peroxide to water This reaction promotes a flux of electrons to the Pt NP thereby obtaining the cathodic current of the electrode. Since the reacted hydrogen peroxide at the Pt NP corresponds to the glucose reacted at the GOx enzyme on the matrix, the current generated is capable of indirectly determining the glucose in the medium.

FIG. 2B shows a schematic representation of the theoretical anodic current generated with an oligoaniline-crosslinked GOx/Au NPs array-modified Au electrode upon presence of glucose in the medium. Using the Au NP and the oligothioaniline linkers allows for directing the electron flux to the Au electrode, thereby forming the anodic current. In the cascade of redox reactions of components of a matrix formed on an electrode of the invention, the ability of the thionaline dimer to switch form an oxidative to a reductive form enables the transition of electrons through the Au NP and to the electrode. Thus, an oligoaniline-crosslinked GOx/Au NPs array-modified Au electrode of the invention directly determines glucose in the analyzed medium.

The invention will now be further illustrated in the following non-limiting examples.

### EXAMPLE 1

Experimental methods

### Platinum Nanoparticles Preparation

A modified version of a synthesis reported by Perez et al. (H. Perez, J. -P. Pradeau, P. -A. Albouy, J. Perez-Omil, Chem. Mater. 1999, 11, 3460) was used. A 300 mg sample of PtCl₄ was dissolved in 75 mL hexylamine (solution 1). Then, 191 mg of thioaniline was dissolved in 30 mL of a 1:1 methanol/hexylamine solution (solution 2). Finally, 300 mg of sodium borohydride was dissolved in 40 mL of a 1:1 water/methanol solution. Following the complete dissolution of sodium borohydride, hexylamine (20 mL) was added (solution 3). Solution 3 was then poured into solution 1 under vigorous stirring at room temperature. The reaction mixture turned brown within a few seconds, and after 1 minute, solution 2 was added to the reaction mixture. After 3 minutes, 200 mL of pure water was added, and the resulting solution was stirred for 15 minutes before being transferred into a separatory funnel.

Following phase separation, the water was removed and the organic phase was repeatedly washed with several 200 mL portions of water. The volume of the organic phase was then reduced to ca. 3-4 mL by rotary evaporation at about 35° C. At the next stage, a solution containing 35 mg thioaniline and 180 mg 2-mercaptoethanesulfonic acid sodium salt in 15 mL ethanol was added to the organic phase and the resulting mixture was stirred overnight. The black solid residue was collected by repetitive centrifugation with diethyl ether (3-4 times). Finally, the precipitate was washed off with pure diethyl ether. A TEM analysis indicated that the size of the modified Pt NPs corresponded to 2±0.3 nm.

### Enzyme Modification

52 mg Glucose Oxidase (EC 1.1.3.4 from Aspergillus niger, 210,000 U·g⁻¹, purchased from Sigma), was dissolved in 3 mL phosphate buffer, 0.1 M (pH=7.4). The solution was then introduced with 52 μL of N-(maleimidocaproyloxy) sulfosuccinimide ester (sulfo-EMCS, obtained from PIERCE), 12 mg·mL⁻¹. The resulting solution was stirred for 40 minutes and was then combined with 0.8 mL 4-aminothiophenol (thioaniline) solution, 1.6 mg mL⁻¹, in ethanol. After 2.5 hours, the solution was eluted through a G-25, column (GE Healthcare) using a phosphate buffer, 0.1 M (pH=7.4) as the eluent. The resulting purified, functionalized-GOx solution was lyophilized to yield a pale-yellow powder that was stored under −20° C.

### Electrode Polymerization and Testing

Clean Au wires (0.3 cm²) were reacted for 2 hours with 10 mM thioaniline solution in ethanol. The modified electrodes were electropolymerized with the thioaniline-modified Pt NPs in the presence or the absence of the thioaniline-modified GOx, using a fixed number of repetitive cyclic voltammetry scans, ranging between −0.1 and 1.1 V vs. SCE, at a scan rate of 100 mV·s⁻¹, in a phosphate buffer, 0.1 M (pH=7.4). All electrochemical measurements were performed while employing a PC-controlled (Autolab GPES software) potentiostat/galvanostat (μAutolab, type III). A graphite rod (d=5 mm) was used as the counter electrode and the reference was a saturated calomel electrode (SCE).

### RESULTS

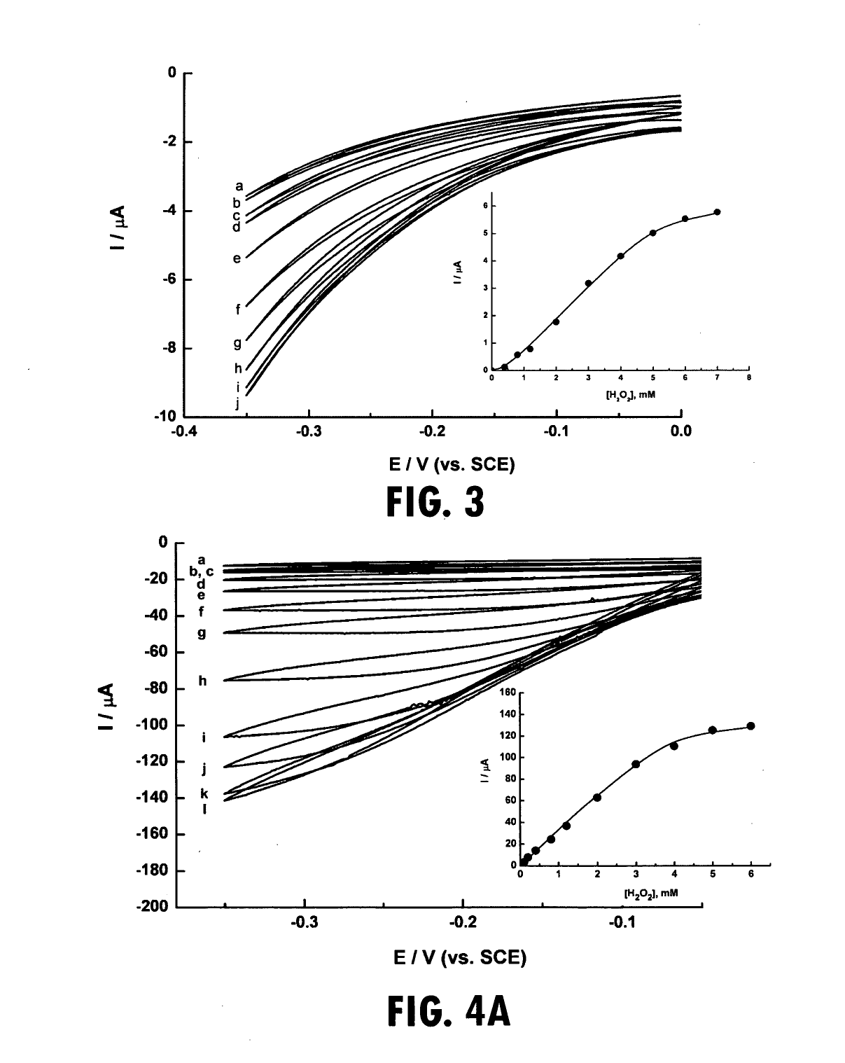

Pt NPs were capped with a mixed monolayer of thioaniline and mercaptoethane sulfonic acid. While the thioaniline provides the electropolymerizable monomer units, the mercaptoethanesulfonate units enhance the stability of the Pt NPs against aggregation and precipitation in aqueous media. The functionalized Pt NPs were covalently tethered to Au electrodes that were functionalized with mercaptopropionic acid in a manner as illustrated under (A) in FIG. 1, to form a two-dimensional monolayer of Pt NPs. FIG. 3 shows the cyclic voltammograms of the Pt NPs-modified electrode upon addition of H₂O₂. Evidently, in the presence of H₂O₂ electrocatalytic cathodic waves are observed, and as the concentration of H₂O₂ is elevated, the intensities of the electrocatalytic currents are enhanced. In a control experiment, no electrocatalytic currents in this potential range could be observed at a base Au electrode, lacking the Pt NPs. These results suggest that the Pt NPs electrocatalyzed the reduction of H₂O₂. The calibration corresponding to the amperometric response of the Pt NPs-modified electrode at E=−0.35 V vs. SCE, in the presence of variable concentrations of H₂O₂. is depicted in the inset of FIG. 1.

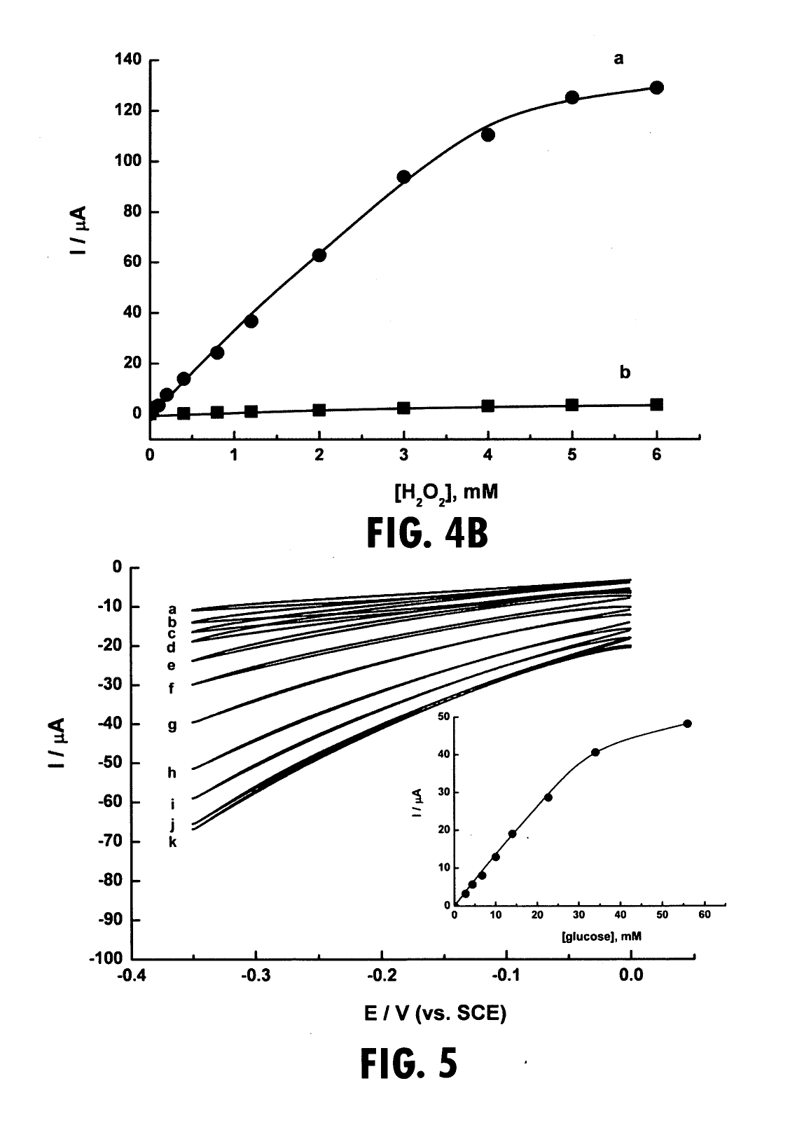

In another experiment the thioaniline-modified Pt NPs were electropolymerized on thioaniline-functionalized Au electrodes in a manner as shown under (B) in FIG. 1. FIG. 4A shows the cyclic voltammograms observed upon analyzing different concentrations of H₂O₂ by the Pt NPs-crosslinked-electrode, produced by 60 electropolymerization cycles. The inset in this figure depicts the derived calibration curve, where the amperometric responses at E=−0.35 V vs. SCE are plotted as a function of the H₂O₂ in the system. The effectiveness of the 3D-Pt NP-functionalized electrode towards the analysis of H₂O₂ as compared to an electrode with a Pt NP monolayer is shown in FIG. 4B.

The success to enhance the sensitivity of analysis towards H₂O₂ by the Pt-NPs-modified electrodes, suggested that the electrode could be applied for the analysis of glucose in the presence of glucose oxidase. As glucose oxidase, GOx, oxidizes glucose by O₂ to form gluconic acid and H₂O₂, the generated H₂O₂ relates to the concentration of glucose, and its electrochemical detection by the electrocatalytic electrode provides a quantitative measure for glucose. FIG. 5 shows the cyclic voltammograms obtained through electrocatalyzed reduction of H₂O₂ at different concentrations of glucose and in the presence of GOx, 0.5 mg·ml⁻¹, for a fixed time-interval of 4 minutes. As the concentration of glucose increases, the electrocatalytic cathodic waves corresponding to the reduction of H₂O₂ are intensified, consistent with the enzymatic reaction mechanism. The inset in FIG. 5 shows the obtained calibration curve.

For a practical utility the enzyme and the electrocatalytic Pt NPs should preferably be integrated on the electrode. To achieve this goal, GOx was functionalized with electropolymerizable thioaniline units in a manner as illustrated under (A) in FIG. 2. The primary functionalization of the lysine residues with the bridged maleimide-active ester, (1), was followed by the Michael addition of thioaniline to the maleimide residues. The average loading of the thioaniline was estimated to be about 5 residues per protein, and the activity of the resulting thioaniline-functionalized GOx indicated about 95% of the activity of the native GOx, prior to the modification. The integrated Pt NPs-GOx composite electrode was prepared by the electropolymerization of the thioaniline-modified Pt NPs in the presence of the thioaniline-functionalized GOx in a manner as illustrated under (B) in FIG. 2. The electropolymerized Pt-NPs provide the 3D conductivity for the covalent electrochemical attachment of the GOx units. The resulting Pt NPs/GOx composite reveals biocatalytic activities of GOx.

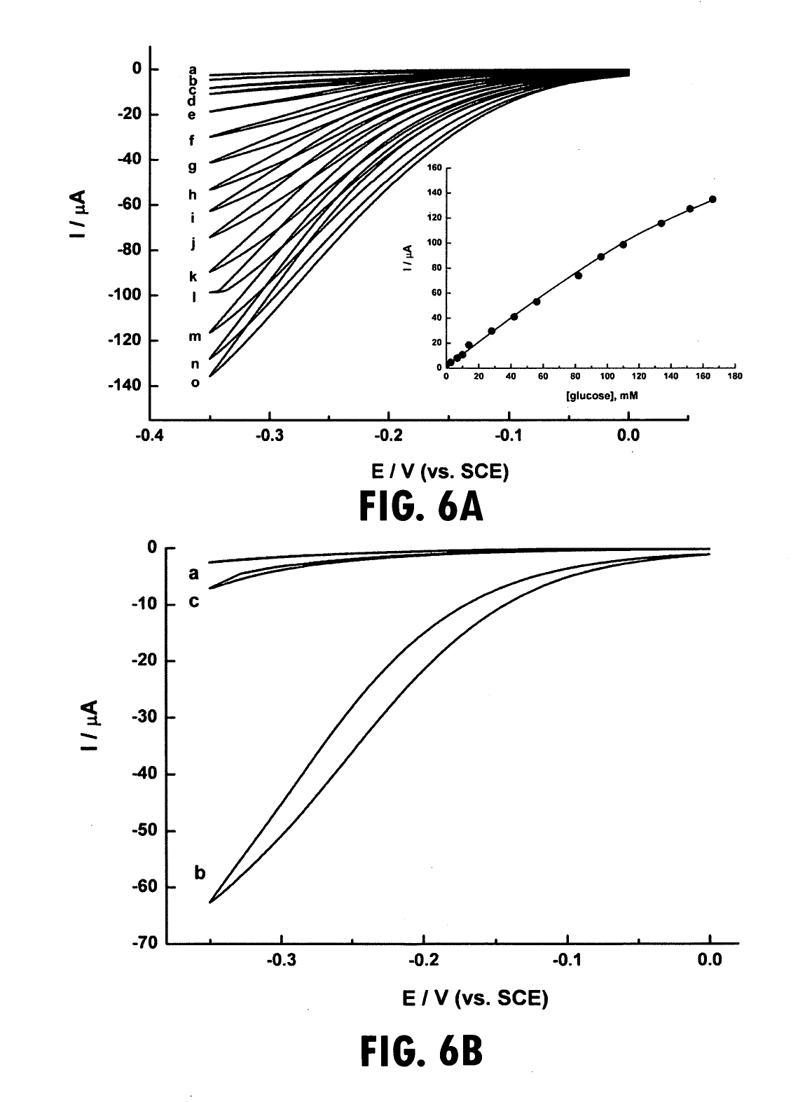

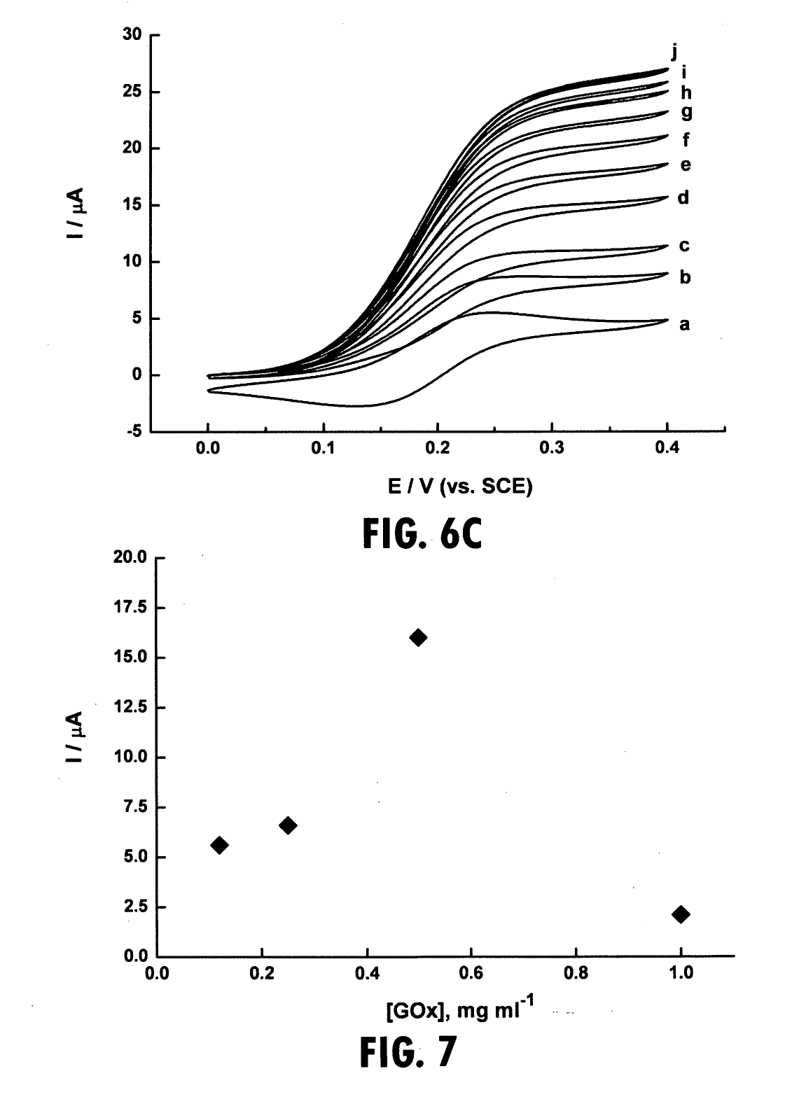

FIG. 6A shows the cyclic voltammograms of a Pt NPs/GOx composite electrode, generated upon the electropolymerization of the particles and the enzyme at a molar ratio of about 2.5:1, and upon the application of 60 electropolymerization cycles, in the presence of variable concentrations of glucose (for the effects of the ratio of Pt NPs:GOx, as well as the number of electropolymerization cycles on the performances of the bioelectrocatalytic electrodes, see below). As can be seen, an increase in the concentration of glucose enhances the electrocatalytic cathodic currents. The inset of FIG. 6A shows the derived calibration curve. The current response of the electrode is linear in the concentration range of about 0 to 120 mM, a broad domain that contains the appropriate region for analyzing sugar levels for diabetes.

The activity of the crosslinked Pt NPs/GOx composites has been confirmed by two complementary experiments. In one experiment, the results of which can be seen in FIG. 6B, it was confirmed that the electrocatalytic reduction wave, observed in the electrochemical studies, originates, indeed, from the reduction of GOx-generated H₂O₂. FIG. 6B, curve (b) depicts the cyclic voltammogram that is attributed to the Pt NPs-catalyzed reduction of the H₂O₂ generated by the GOx-mediated oxidation of glucose. FIG. 6B, curve (c) shows, however, the cyclic voltammogram of the Pt NPs/GOx composite in the presence of glucose, upon the co-addition of catalase to the electrolyte solution. Evidently, the addition of catalase depleted the electrocatalytic cathodic wave, consistent with the fact that catalase decomposes H₂O₂ through a disproportionation mechanism. Further support that the enzyme GOx exists in a catalytically-active configuration was obtained by the activation of the bioelectrocatalytic functions of the enzyme, in the presence of a diffusional electron mediator. FIG. 6C shows the cyclic voltammograms of the Pt NPs/GOx functionalized electrode upon the oxidation of glucose using ferrocene methanol (FM) as a diffusional electron mediator. The electrocatalytic currents are observed only in the presence of FM and only upon the addition of glucose. These results indicate that GOx is in a biologically-active structure and its bioelectrocatalytic functions are activated by the diffusional electron mediator.

While the electropolymerization of the Pt NPs contributes to the 3D conductivity of the matrix, the bioelectrocatalytic functions are controlled by the enzyme content in the matrix (the H₂O₂ generating units) and the coverage of the Pt NPs sites. While at first glance, it seems that high loading of the enzyme during electropolymerization would be an advantage, due to the enhanced biocatalytic generation of H₂O₂ by GOx in the matrix, the use of high content of enzyme in the electropolymerization mixture would favor the incorporation of protein units around the particles, and this would insulate the particles and prevent further growth of the NPs/GOx matrix. Thus, preferably an appropriate balance between the electropolymerizable Pt NPs and electropolymerizable enzyme should be retained to yield a Pt NPs/GOx composite with optimal bioelectrocatalytic functions.

FIG. 7 shows the electrocatalytic cathodic current generated by Pt NPs/GOx composite electrodes, using 60 electropolymerization cycles, while changing the ratio of electropolymerizable Pt NPs and GOx. The concentration of the Pt NPs was kept constant (0.4 mg ' mL⁻¹) while the concentration of GOx was varied. In this set of experiments, the concentration of glucose was kept low, 14 mM, to ensure that the electrocatalytic cathodic currents are significantly below the saturation currents. As expected, by increasing the concentrations of GOx during the electropolymerization stage, the bioelectrocatalytic activity of the electrode increases, and the electrocatalytic cathodic currents reach a peak value at a concentration of glucose oxidase that corresponds to about 0.5 mg·mL⁻¹. Beyond this GOx concentration the current drops and ultimately, the electrocatalytic activity diminishes. This lack of bioelectrocatalytic activity of the electrode generated at high concentrations of GOx may be attributed to the favored electropolymerization of the enzyme film on the electrode, while preventing the incorporation of the Pt NPs, or to the rapid insulation of the electropolymerized NPs by the enzyme, which prevents further electropolymerization and masks the catalytic functions of the Pt NPs. The insulation of the Pt NPs by the electropolymerized GOx seems to be particularly important since blocking the three dimensional conductivity prevents, also, the accumulation of GOx in the resulting composite associated with the electrode. The optimal bioelectrocatalytic functions of the composite electrodes were observed at a molar ratio of electropolymerizable Pt NPs:GOx that corresponds to about 2.5:1.0. Accordingly, all of the Pt NPs/GOx electrodes described above were prepared using these optimal conditions.

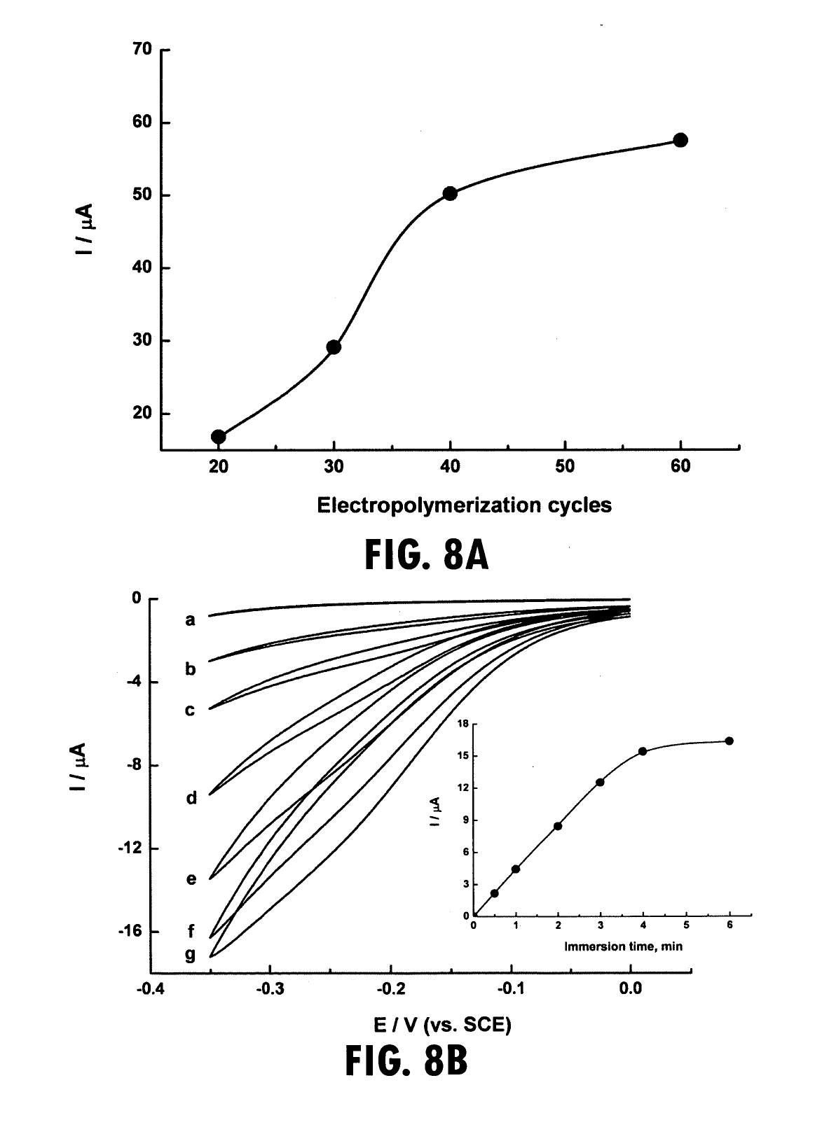

The bioelectrocatalytic currents may be controlled by the number of electropolymerization cycles applied during the generation of the Pt NPs/GOx electrodes in the presence of the optimal Pt NPs:GOx ratio (2.5:1.0). This is represented in FIG. 8A. As the number of polymerization cycles increases, the bioelectrocatalytic currents are intensified and after 60 cycles, the biocatalytic currents level off and seem to approach saturation value. Without intending to be bound by theory, the saturated value of the electrocatalytic cathodic current may be attributed to several reasons: (i) as electropolymerization proceeds the three-dimensional conductivity of the Pt NPs is perturbed by the insulating enzymes, and this eliminates the further electropolymerization of the active components; and/or (ii) As polymerization proceeds, inner Pt NP and enzyme layers are inaccessible to glucose/H₂O₂ and thus, the layers do not contribute to the total cathodic currents. On the basis of such experiments 60 electropolymerization cycles were applied to prepare the electrodes in the experiments of this Example.

The bioelectrocatalytic cathodic currents are also controlled by the time period in which the functionalized electrode is permitted to interact with glucose in the solution, to yield H₂O₂. This is represented in FIG. 8B. As the biocatalytic reaction is prolonged, the electrocatalytic cathodic currents increase, until they level off to a saturation value after about 4-6 minutes. Without intending to be bound by theory, the phenomenon may be explained by the fact that H₂O₂ is generated at the thin enzyme film at the electrode surface, and it diffuses out to the bulk electrolyte solution, which, by virtue of being devoid of H₂O₂, is a sink for it. After 6 minutes, an equilibrium is established where the flux of H₂O₂ diffusing to the bulk electrolyte is identical to the H₂O₂ flux generated by the enzyme film, thus leading to the saturated cathodic current.

### EXAMPLE 2

### Experimental Methods

Gold Nanoparticles preparation

Au nanoparticles functionalized with 2-mercaptoethane sulfonic acid and p-aminothiophenol (Au-NPs) were prepared by mixing a 10 ml solution containing 197 mg HAuCl₄ in ethanol and a 5 ml solution containing 42 mg mercaptoethane sulfonate and 8 mg p-aminothiophenol in methanol. The two solutions were stirred in the presence of 2.5 ml glacial acetic acid on an ice bath for 1 hour. Subsequently, 7.5 ml aqueous solution of 1 M sodium borhydride, NaBH₄, was added dropwise, resulting in a dark color solution associated with the presence of the Au-NPs. The solution was stirred for 1 additional hour in an ice bath, and then for 14 hours at room temperature. The particles were successively washed and centrifuged (twice in each solvent) with methanol, ethanol and diethyl ether. An average particle size of 3.6±0.3 nm was estimated using TEM (FIG. 1C).

### Enzyme Modification

Enzyme modification was carried out as generally described in Example 1.

### Electrode Polymerization and Testing

Clean Au wires (0.3 cm²) were reacted for 2 hours with 10 mM thioaniline solution in ethanol. The modified electrodes were electropolymerized with thioaniline-modified Au NPs and thioaniline-modified GOx in a phosphate buffer, 0.1 M (pH=7.4), using a fixed number of repetitive cyclic voltammetry scans, ranging between −0.1 and 1.1 V vs. SCE, and at a scan rate of 100 mV·s⁻¹. All electrochemical measurements were performed employing a PC-controlled (Autolab GPES software) potentiostat/galvanostat (μAutolab, type III). A graphite rod (d=5 mm) was used as the counter electrode and the reference was a saturated calomel electrode (SCE).

### RESULTS

The assembly of the biosensing electrodes was carried out as generally outlined in FIG. 2, with Au particles being used instead of Pt.

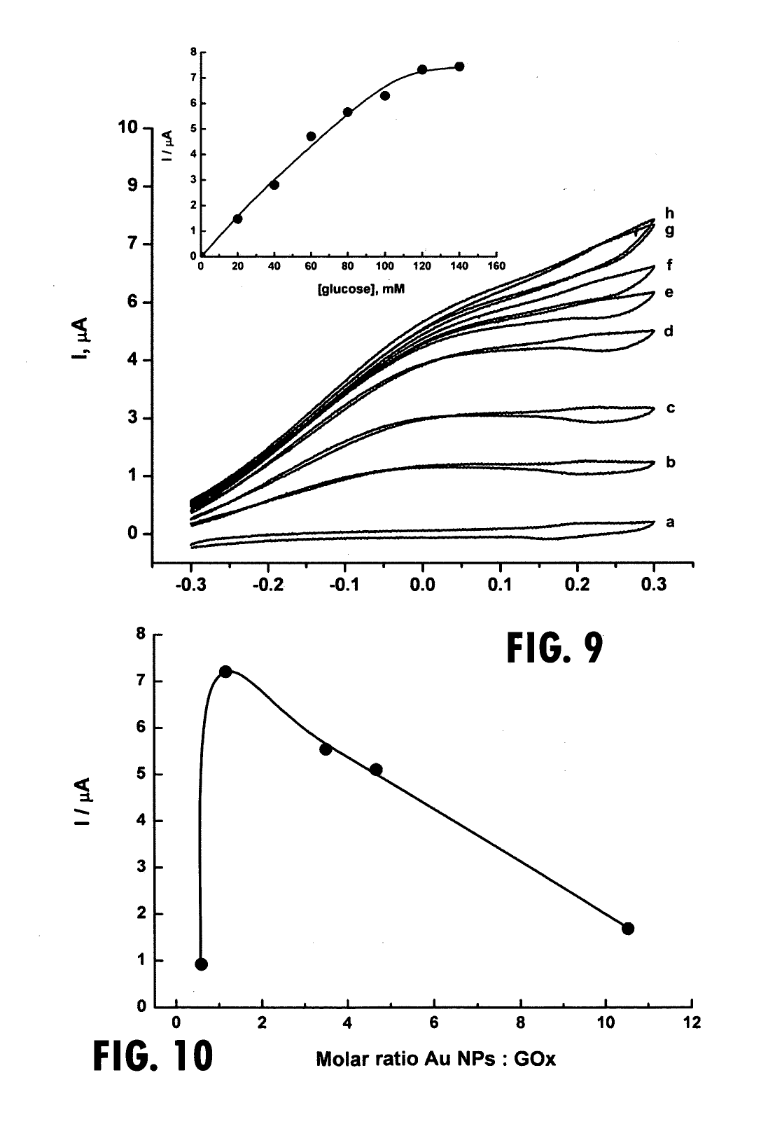

FIG. 9 shows the electrocatalytic anodic currents observed upon analyzing different concentrations of glucose by the Au NPs/GOx-functionalized electrode. In this experiment the electrode was constructed by applying 60 electropolymerization cycles, and the molar ratio of the Au NPs to thioaniline-modified GOx in the electropolymerization solution was 3.6 (for the selection of the number of electropolymerization cycles, and the respective ratio of the Au NPs:thioaniline-GOx, see below). As the concentration of the glucose increases, the electrocatalytic anodic currents are intensified. The inset of FIG. 9 shows the derived calibration curve, where the current responses at E=0.3 V vs. SCE are plotted as a function of the concentration of glucose. Similarly to the finding of FIG. 1, the calibration curve is linear up to about 120 mM glucose. The responses of the electrode are well adequate for the analysis of glucose in diabetes.

FIG. 10 depicts the amperometric responses of the Au NPs/GOx composite electrodes electropolymerized in the presence of different concentrations of Au NPs:GOx. A molar ratio of the Au NPs:GOx of about 1.2, appears to yield a peak performance in the bioelectrocatalytic activity of the electrode d.

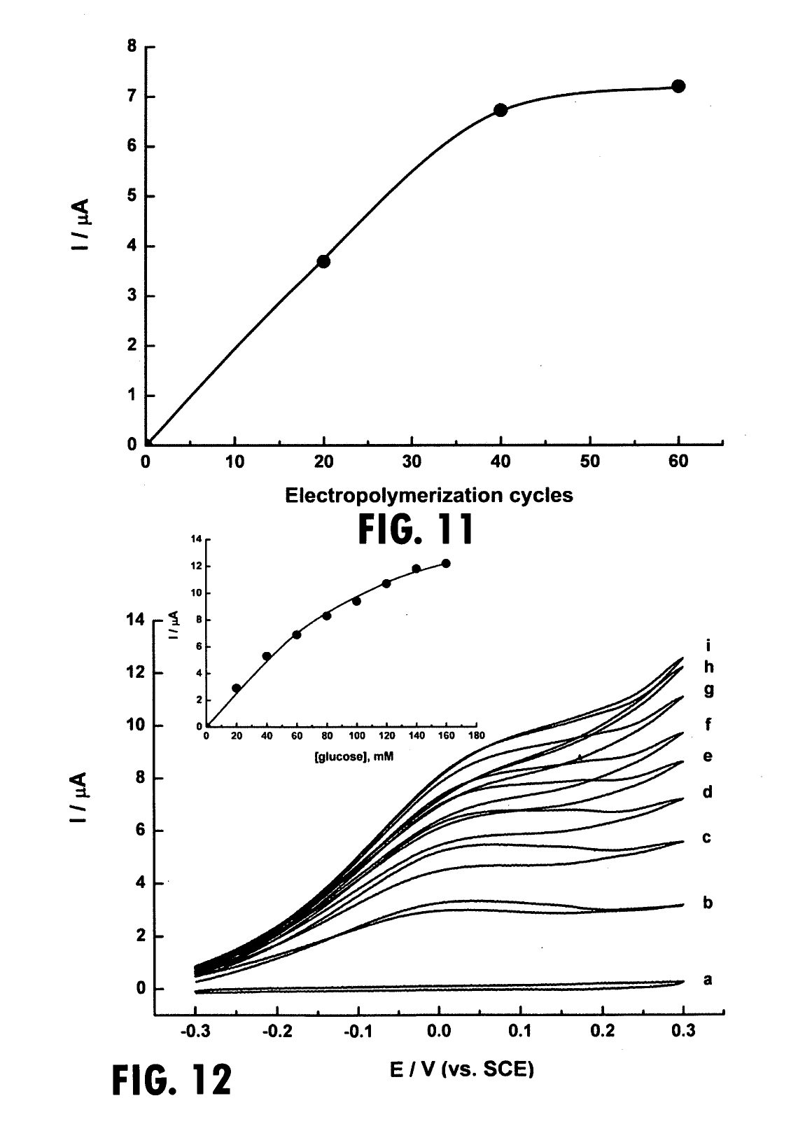

FIG. 11 shows the electrocatalytic anodic currents generated by the Au NPs/GOx composite electrodes, prepared by applying variable number of electropolymerization cycles, and upon using an optimized Au NP:GOx ratio of 1.2 in the electropolymerization solution. The bioelectrocatalytic anodic currents were recorded in the presence of a fixed concentration of glucose of 60 mM. As the number of electropolymerization cycles increases, the bioelectrocatalytic currents are intensified, and they level off after about 40-60 cycles. Without intending to be bound by theory, the increase in the amperometric responses may be attributed to the higher contents of the enzyme in the resulting Au NPs/GOx composite electrodes, while the saturation of the currents may be attributed to the gradually increasing perturbations in the conductivity paths of the Au NPs attaching the enzyme units, as electropolymerization proceeds. Alternatively, inner parts of the Au NPs/GOx composite might become inaccessible to glucose as electropolymerization proceeds.

FIG. 12 demonstrates the electrocatalytic currents observed upon analyzing different concentrations of glucose by the Au NPs/GOx functionalized electrodes, assembled under the presumed optimized conditions, noted above. The saturation current represents the highest turnover rates of electrons between the biocatalytic matrix and the electrode.

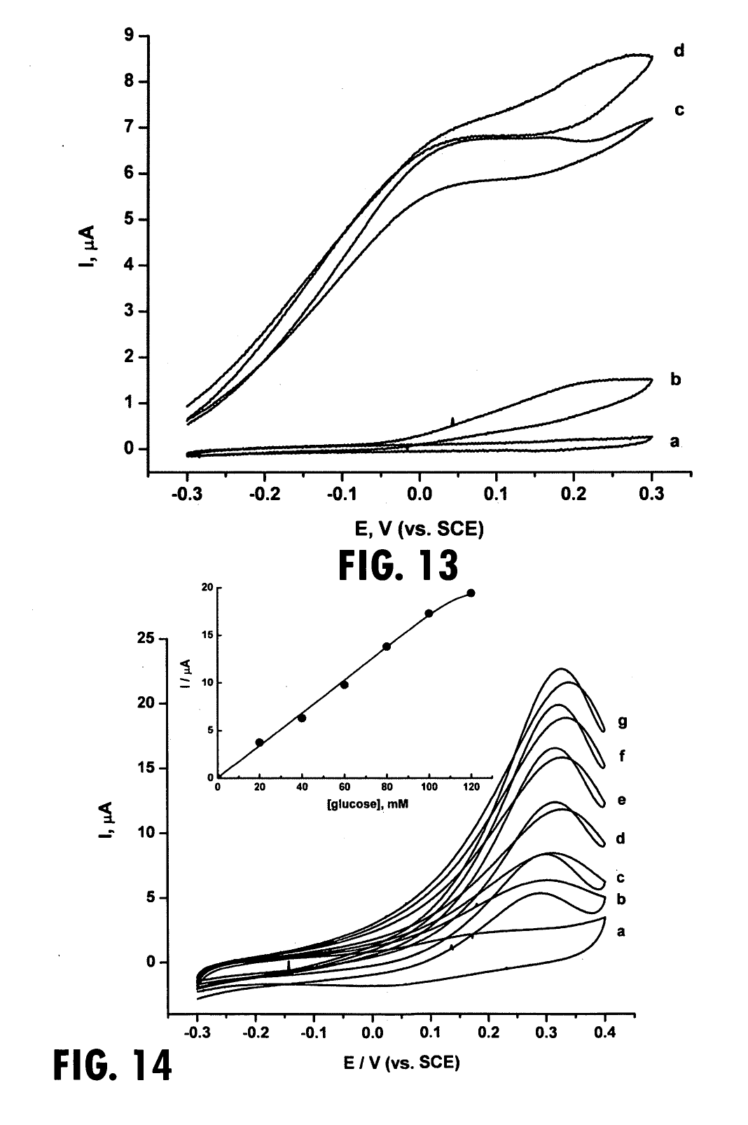

FIG. 13 depicts the amperometric responses of a Au NPs/GOx electrode in the presence of a common interferant for glucose sensing—ascorbic acid. As can be seen, this interferant has a minute effect on the resulting current (<3-8% in the region 0-0.1 V) in part by the effective electrical contacting of the enzyme by the Au NPs/GOx composite. Upon testing the optimized electrodes for glucose oxidation in an air saturated atmosphere, we have also detected a marginal reduction in the intensities of the electrocatalytic currents. This observation is attributed to the efficient electrical contacting of the electropolymerized enzyme with the Au NPs relays, and hence with the electrode, providing an effective competition with the O₂ biocatalyzed oxidation of glucose, and thus allowing the analysis of glucose under aerobic conditions.

The use of the electropolymerized, electrically contacted enzyme electrodes for invasive monitoring of glucose in subcutaneous fluids may require the enhancement of the amperometric responses, in order to miniaturize the devices. One way to achieve this goal would be to roughen the surface of the electrode so as to increase its effective surface area. The electrode surface was roughened by the amalgamization of the Au with mercury, and the subsequent removal of the amalgam by concentrated nitric acid. FIG. 14 shows the amperometric responses of a roughened, Au NPs/GOx functionalized electrode, generated by 60 cycles under the above-noted optimal Au NPs:GOx ratio, upon analyzing various concentrations of glucose. As can be see, the amperometric responses are up to about 80% higher than an analogous, non pretreated electrode, due to the effective roughening of the surface area.

1. An electrode comprising: a conductive surface and a matrix bound thereto; the matrix comprises at least two species of components that comprise one or more species of enzymes and one or more species of metal nanonparticle, the components being covalently bound to one another through one or more first binding moieties and the matrix being covalently bound to the conductive surface through one or more same or different second binding moieties.

2. An electrode according to claim 1, comprising: a conductive surface and a matrix bound thereto; the matrix comprises at least two types of components that comprise (i) one or more enzyme species that can catalyze a reaction in which an analyte is reacted to yield a product and (ii) and one or more metal nanonparticle species; the catalysis altering the electric properties or response of the electrode, the components being covalently bound to one another through one or more first binding moieties and the matrix being covalently bound to the conductive surface through one or more same or different second binding moieties.

3. An electrode according to claim 1, wherein the components are bound to one another via linker groups that can mediate an electron transfer.

4. An electrode according to claim 1, adapted for determining an analyte in a medium.

5. An electrode according to claim 1, wherein said enzyme is a redox enzyme.

6. An electrode according to claim 5, wherein said enzyme is selected from glucose oxidase, lactate oxidase, choline oxidase, cholesterol oxidase and xanthine oxidase.

7. An electrode according to claim 1, wherein the metal nanoparticles are one or more of platinum, palladium, iridium, gold, silver, nickel, thallium.

8. An electrode according to claim 1, wherein said matrix is linked to the conductive surface by a linker group having the general formula (I):
Z-L-X (I)
wherein Z is a moiety that can chemically associate with, bind to or chemically sorb onto the conductive surface; L is a chemical bond or a spacer group; and X is a functional group that can bind to one or more other X groups or other functional groups linked to the enzyme or a nanoparticles to form said second binding moiety.

9. An electrode according to claim 8, wherein Z is a sulfur-containing moiety and X is an aniline group.

10. An electrode according to claim 9, wherein said linkers are thioaniline groups.

11. An electrode according to claim 1, wherein said nanoparticles are linked to one or more of (i) the conductive surface and (ii) at least one other component of the matrix through linker groups of the general formula (II):
Z′-L′-X′ (II)
wherein Z′ may be the same or different than Z and is a moiety that can chemically associate with, bind to or chemically sorb onto the nanoparticle; L′ is a chemical bond or a spacer group; and X′ is a functional group that can bind to one or more other X′ groups or other functional groups linked to the conductive surface to form said second binding moiety or an enzyme to form said first binding moiety.

12. An electrode according to claim 11, wherein Z′ is a sulfur-containing moiety and X′ is an aniline group.

13. An electrode according to claim 12, wherein said linkers are thioaniline groups.

14. An electrode according to claim 1, wherein said enzymes are linked to one or more of (i) the conductive surface and (ii) at least one other component of the matrix through linker groups of the general formula (IV):
—Y-L″-X″ (IV)
wherein —Y is a moiety that is covalently bound to the enzyme; L″ is a chemical bond or a spacer moiety; and X″ is a functional group that can bind to one or more other X″ group or other functional groups linked to the conductive surface to form said second binding moiety or a nanoparticle to form said first binding moiety.

15. An electrode according to claim 14, wherein —Y is a moiety bound to the enzyme by an amide bond; and X″ is an aniline group.

16. An electrode according to claim 15, wherein X″ is thioaniline group.

17. An electrode according to claim 1, wherein said matrix is formed through electroploymerization.

18. A sensor system for determining an analyte in a medium, comprising an electrode according to claim 1.

19. A sensor system according to claim 18, wherein the enzyme is glucose oxidase and the analyte is glucose.

20-22. (canceled)

23. A device comprising one or more electrodes according to claim 1, said device is selected from the group consisting an electrochemical cell, a measuring device for determining an analyte in a medium and a sensing system.

24. (canceled)

25. A device according to claim 20, being an implantable device for determining an analyte in a body fluid of a subject.

26-29. (canceled)
